(19) United States
(12) Patent Application Publication
(10) Pub. No.: US 2021/0354595 A1
(43) Pub. Date: Nov. 18, 2021

(54) SENSOR CARRIER TO CARRY ONE OR MORE SENSOR ELEMENTS AND CABLING

(71) Applicant: IEE INTERNATIONAL ELECTRONICS & ENGINEERING S.A., Echtemach (LU)

(72) Inventors: Harald SCHON, Seinsfeld (DE); Dietmar JUNGEN, Mehren (DE)

(21) Appl. No.: 16/319,133

(22) PCT Filed: Jul. 19, 2017
(86) PCT No.: PCT/EP2017/068263

§ 371 Date: Jan. 18, 2019

(30) Foreign Application Priority Data
Jul. 22, 2016 (LU) 93 159

(51) Int. Cl. B60N 2/00; G01V 3/00

(52) U.S. Cl. CPC B60N 2/002; G01V 3/00

(57) ABSTRACT

A sensor carrier is configured for being arranged on a seat-supporting structure component of a vehicle and for carrying at least one vehicle seat occupation sensor. The sensor carrier includes an upper surface and a bottom surface. The upper surface comprises at least one plane support area for supporting the at least one vehicle seat occupation sensor. At least one portion of the bottom surface is designed to follow a specified surface contour of a seat-supporting structure component of a vehicle such that a predetermined measure considering shortest distances between a plurality of reference locations of the portion of the bottom surface and corresponding reference locations of the specified surface contour of the seat-supporting structure component, in an installed state of the sensor carrier, are kept below a predetermined threshold value for the measure.

### TECHNICAL FIELD

The invention relates to a sensor carrier for being arranged on a structure component of a vehicle and for carrying at least one vehicle seat occupation sensor, and a vehicle seat occupation sensor unit comprising such sensor carrier.

### BACKGROUND OF THE INVENTION

Employing various types of sensors for sensing different physical quantities (e.g. mechanical force, temperature, humidity, etc.) in or at vehicle seats is widespread nowadays. In particular, vehicle seat occupation detection systems are nowadays widely used in vehicles, in particular in passenger cars, for providing a seat occupation signal for various appliances, for instance for the purpose of a seat belt reminder (SBR) system or an activation control for an auxiliary restraint system (ARS). Seat occupation detection systems include seat occupation sensors that are known to exist in a number of variants, e.g. based on capacitive sensing, on deformation sensing or on sensing of pressure/force. In order to meet requirements regarding easy integration and desired robustness, weight-sensitive seat occupation sensors have typically been arranged on the B-surface of a vehicle seat, i.e. between a foam body of a seat cushion and a seat pan or cushion-supporting springs of the vehicle seat.

Further, vehicle seat occupation detection systems are known to be employed as a means of assessing a potential activation of an installed vehicle passenger restraint system, such as an airbag.

In the application of seat occupation detection systems for vehicles, it often occurs that seat-supporting vehicle structures, for instance a seat pan or a car body portion supporting a rear seat bench, provide only uneven and partly not rigid surfaces between a seat cushion and the seat-supporting vehicle structure. This can be an obstacle for implementing an easy and fast sensor integration and installation procedure.

### SUMMARY

It is therefore an object of the invention to provide a vehicle seat occupation sensor unit that can enable a seat occupation sensor integration and installation procedure that is improved with regard to shorter installation time and less effort and/or complexity and larger reliability.

The term “vehicle”, as used in this application, shall particularly be understood to encompass, but not to be limited to, passenger cars, trucks and buses.

In one aspect of the present invention, the object is achieved by a sensor carrier for being arranged on a seat-supporting structure component of a vehicle and for carrying at least one vehicle seat occupation sensor. The sensor carrier includes an upper surface comprising at least one plane support area for supporting the at least one vehicle seat occupation sensor. The sensor carrier further includes a bottom surface that is arranged opposite to the upper surface. At least one portion of the bottom surface is designed to follow a specified surface contour of a seat-supporting structure component of a vehicle such that a predetermined measure considering shortest distances between a plurality of reference locations of the portion of the bottom surface and corresponding reference locations of the specified surface contour of the seat-supporting structure component, in an installed state of the sensor carrier, are kept below a predetermined threshold value for the measure.

For sensor carriers that are hardly deflected by the weight of a seat cushion, for instance by less than 5% in height, an employable predetermined measure may be the sum of absolute values of the shortest distances between reference locations of a plurality of reference locations of the portion of the bottom surface and their corresponding reference locations of the specified surface contour of the seat-supporting structure component, wherein the sum is to be taken over all the reference locations of the plurality of reference locations. Alternatively, the predetermined measure may be the maximum value of the before-mentioned shortest distances.

For sensor carriers that are substantially deflected by the weight of a seat cushion, for instance by more than 5% in height, an employable predetermined measure may be the maximum value of the shortest distances between reference locations of a plurality of reference locations of the portion of the bottom surface and corresponding reference locations of the specified surface contour of the seat-supporting structure component.

Other measures known in the art are also contemplated. In general, any measure function that appears suitable to those skilled in the art may be applied.

The terms “upper” and “bottom”, as used in this application, shall particularly be understood with reference to a direction perpendicular to the seat-supporting structure component of the vehicle, wherein “upper” shall be understood as being arranged further remote and “bottom” shall be understood as being arranged closer to the seat-supporting structure component.

The disclosed solution provides an easy and cost-efficient manner for pre-installing a vehicle seat occupation sensor in the sensor carrier, and for finally installing the vehicle seat occupation sensor in a single step with the sensor carrier in the vehicle. Further, the vehicle seat occupation sensor can be arranged at and can be attached to a mechanical support in a way that is close to an optimum, to a large extent independent of the shape of the seat-supporting structure component of the vehicle. This can result in an improved sensor performance and larger sensor reliability.

Depending on the seat-supporting structure component, the sensor carrier can be designed as a single piece or it can be designed to comprise at least two pieces that, in the installed state, are intended to mechanically cooperate to form a single sensor carrier.

Although the primary purpose of the disclosed sensor carrier is to carry the at least one vehicle seat occupation sensor, it is also contemplated to pre-install sensors for sensing other physical quantities (such as temperature, humidity, etc.) in the same sensor carrier.

In preferred embodiments, the at least one plane support area is either a superficial upper plane area or a lower-lying plane area at the bottom of an indentation in the upper surface. A superficial upper plane area provides the benefit of an easy design and an easy manufacturing of the plane support area. A lower-lying plane area at the bottom of an indentation requires more design effort but provides an improved protection of the part of the vehicle seat occupation sensor that is not intended to be exposed to mechanical load generated by a seat occupant. In particular, a lower-lying plane area at the bottom of an indentation provides an improved protection against an undesired and unintended displacement of the vehicle seat occupation sensor.

The term “indentation”, as used in this application, shall particularly be understood to encompass an indentation designed as a recess (i.e. by removing material after a manufacturing process of the sensor carrier or by not allowing the presence of material at the indentation during a manufacturing process of the sensor carrier) as well as an indentation created by an irreversible material deformation by employing a pressing process at the end of the of the sensor carrier manufacturing process.

In some embodiments, a mechanical support close to an optimum for the vehicle seat occupation sensor can be provided if the at least one plane support area is horizontally arranged in the installed state of the sensor carrier.

In some embodiments, the sensor carrier further comprises at least one cabling indentation that is configured for at least partially receiving electric cabling that is connectable to the at least one vehicle seat occupation sensor. In this way, the electric cabling can at least partially reside within the cabling indentation for better mechanical protection, which can result in improved vehicle seat occupation sensor reliability.

The vehicle seat occupation sensor reliability can further be improved if the at least one plane support area is a lower-lying plane area at the bottom of an indentation in the upper surface, and if this indentation and the at least one cabling indentation are connected with each other so as to form a continuous indentation.

A better mechanical protection and, as a result, an improved reliability of the vehicle seat occupation sensor can also be accomplished if the sensor carrier further includes at least one cable connector indentation in the upper surface that is designed for receiving a cable connector that is connectable to electric cabling that, in turn, is connectable to the at least one vehicle seat occupation sensor.

Most preferable,
the at least one plane support area of the sensor carrier is a lower-lying plane area at the bottom of an indentation in the upper surface,
the sensor carrier comprises at least one cabling indentation for at least partially receiving an electric cabling,
the indentation comprising the at least one plane support area for supporting the at least one vehicle seat occupation sensor and the cabling indentation are connected with each other so as to form a continuous indentation, and
the sensor carrier comprises a cable connector indentation, and the cabling indentation and the cable connector indentation are connected with each other so as to form a continuous indentation.

In preferred embodiments, a major portion of the sensor carrier is formed as plastic foam material. The phrase “a major part”, as used in this application, shall particularly be understood as a volumetric portion of at least 50%, more preferable of more than 70%, and, most preferable, of more than 80% of the sensor carrier. A volumetric portion of 100% shall as well be encompassed.

The plastic (or polymeric) foam material may be selected from the group of soft (flexible) polymeric foams, for instance flexible polyurethane (PU) foam, but may as well be selected from the group of rigid polymeric foams, for instance expanded polypropylene (EPP), rigid polyurethane (PU) foam, expanded polystyrene foam (EPS) or extruded polystyrene (XPS) foam. It is noted that the material shall not be limited to the disclosed material examples. Rather, any polymeric foam that appears suitable to those skilled in the art is applicable.

In another aspect of the invention, a vehicle seat occupation sensor unit is provided. The vehicle seat occupation sensor unit includes an embodiment of the sensor carrier disclosed herein, a vehicle seat occupation sensor that is disposed on the at least one plane support area, electric cabling that is electrically connected to the vehicle seat occupation sensor, and a cable connector that is electrically connected to the electric cabling.

The benefits described for the embodiments of the sensor carrier apply to such vehicle seat occupation sensor unit to the full extent.

In some embodiments, the vehicle seat occupation sensor unit comprises a plurality of distinct plane support areas and a plurality of vehicle seat occupation sensors. Each vehicle seat occupation sensor of the plurality of vehicle seat occupation sensors is attached to one plane support area out of the plurality of distinct plane support areas. Further, the vehicle seat occupation sensor unit includes electric cabling that is electrically connected to the plurality of vehicle seat occupation sensors, and at least one cable connector that is electrically connected to the electric cabling.

In this manner, a vehicle seat occupation sensor unit with a high degree of design flexibility can be provided.

In some embodiments of the vehicle seat occupation sensor unit, the vehicle seat occupation sensors of the plurality of vehicle seat occupation sensors are designed as pressure-sensitive switches. Preferably, the pressure-sensitive switches are formed by foil-type pressure-sensitive switches that are known in the art.

In some embodiments of the vehicle seat occupation sensor unit, wherein the vehicle seat occupation sensors are designed as pressure-sensitive switches, the vehicle seat occupation sensors of the plurality of vehicle seat occupation sensors are electrically connected in series. Moreover, the vehicle seat occupation sensor unit further comprises a plurality of resistors having distinctive resistance values. One resistor each of the plurality of resistors is electrically connected in parallel to each vehicle seat occupation sensors of the plurality of vehicle seat occupation sensors.

Preferably, a lowest resistance value of the distinctive resistance values of the plurality of resistors is at least ten times larger, more preferable more than twenty times larger, and, most preferable, more than fifty times larger than a largest resistance value of the foil-type pressure-sensitive switches in their closed state.

In this way, a part-saving solution for a vehicle seat occupation sensor unit can be provided.

These and other aspects of the invention will be apparent from and elucidated with reference to the embodiments described hereinafter.

### BRIEF DESCRIPTION OF THE DRAWINGS

Further details and advantages of the present invention will be apparent from the following detailed description of not limiting embodiments with reference to the attached drawing, wherein:

FIG. 1 shows a sensor carrier in accordance with an embodiment of the invention in a perspective view;

FIG. 2 schematically illustrates, in a perspective view, a vehicle seat occupation sensor unit comprising the sensor carrier pursuant to FIG. 1 installed on a seat-supporting structure component of a vehicle;

FIG. 3 schematically shows an alternative sensor carrier in accordance with an embodiment of the invention in a perspective view;

FIG. 4 is a perspective view of an alternative vehicle seat occupation sensor unit comprising the alternative sensor carrier pursuant to FIG. 3 installed on the seat-supporting structure component of the vehicle pursuant to FIG. 2;

FIG. 5 is an electric circuit diagram of a plurality of three vehicle seat occupation sensors of another alternative vehicle seat occupation sensor unit;

FIG. 6 schematically illustrates a configuration of components of a vehicle seat occupation sensor unit comprising the plurality of vehicle seat occupation sensors pursuant to FIG. 5; and

FIG. 7 schematically illustrates an alternative configuration of the components of the vehicle seat occupation sensor unit pursuant to FIG. 6.

### DESCRIPTION OF PREFERRED EMBODIMENTS

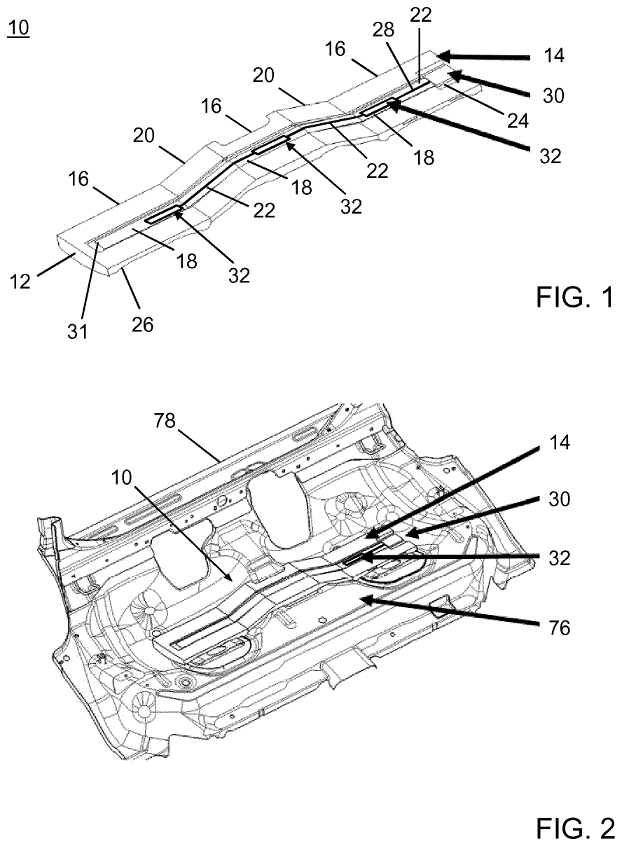

FIGS. 1 and 2 show a vehicle seat occupation sensor unit 10 comprising a sensor carrier 12 in accordance with an embodiment of the invention, in a perspective view. The sensor carrier 12 is configured for being arranged on a seat-supporting structure component of a vehicle and for carrying at least one vehicle seat occupation sensor. In an installed state of the seat, the at least one vehicle seat occupation sensor is arranged at a bottom surface of a seat cushion (B side, seat cushion not shown) of the seat such that the sensor carrier 12 is sandwiched between the seat cushion and the seat-supporting structure component.

FIG. 2 schematically illustrates, in the same perspective view as in FIG. 1, the vehicle seat occupation sensor unit 10 comprising the sensor carrier 12 pursuant to FIG. 1, installed on a seat-supporting structure component 76 of a vehicle. The seat-supporting structure component 76 is designed as a rear bench support of a passenger car and forms part of the passenger car body 78.

The sensor carrier 12 is completely made from expanded polypropylene (EPP). In a top view, the sensor carrier 12 has a substantially rectangular shape.

The sensor carrier 12 includes an upper surface 14 comprising three plane portions 16 that have a plane support area 18 for supporting vehicle seat occupation sensors. As illustrated in FIG. 2, in the installed state of the sensor carrier 12 the three plane support areas 18 are horizontally arranged, wherein the centered plane support area 18 is arranged at an elevated position relative to the other two. Each one of the three plane support areas 18 is designed as a lower-lying plane area at the bottom of an indentation in the upper surface 14. In another embodiment, the plane support areas may be designed as superficial upper plane areas. The sensor carrier 12 also comprises inclined plane surface portions 20 interconnecting the three plane portions 16.

The vehicle seat occupation sensor unit 10 includes one strip-shaped sensor unit comprising a plurality of vehicle seat occupation sensors 32 interconnected by electric cabling 28. The arrangement is such that each vehicle seat occupation sensor 32 is arranged on one plane support area 18. The strip-shaped sensor unit with the vehicle seat occupation sensors 32 is attached to the plane support area 18 by suitable means, for instance by using an adhesive or by employing clamps or snap-fits. Such means are well known to those skilled in the art and therefore need not be discussed in further detail herein.

The sensor carrier 12 further comprises a bottom surface 26 that is arranged opposite to the upper surface 14. The bottom surface 26 is designed to follow a specified surface contour, which is the actual surface contour of the seat-supporting structure component 76 of the vehicle.

The vehicle seat occupation sensor unit 10 further comprises electric cabling 28 that is electrically connected to the vehicle seat occupation sensor 32. The sensor carrier 12 comprises an elongated cabling indentation 22 that is configured for receiving the electric cabling 28. The indentations having a lower-lying plane area and the elongated cabling indentation 22 are connected with each other so as to form a continuous indentation.

Furthermore, the vehicle seat occupation sensor unit 10 includes a cable connector 30 that is electrically connected to the electric cabling 28, which, in turn, is connected to the vehicle seat occupation sensor 32. Located at a shorter edge of the substantially rectangular shape, the sensor carrier 12 includes a cable connector indentation 24 in the upper surface 14 that is designed for receiving the cable connector 30.

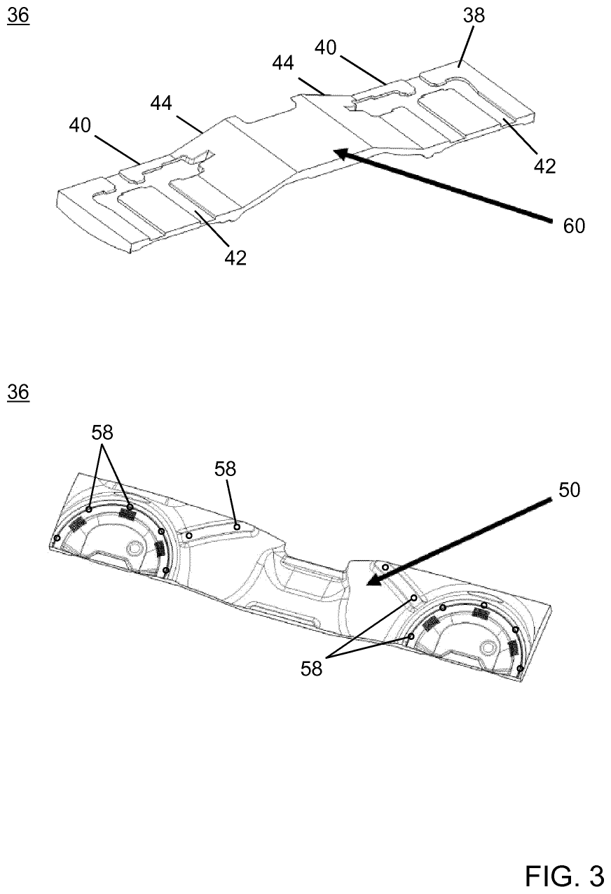

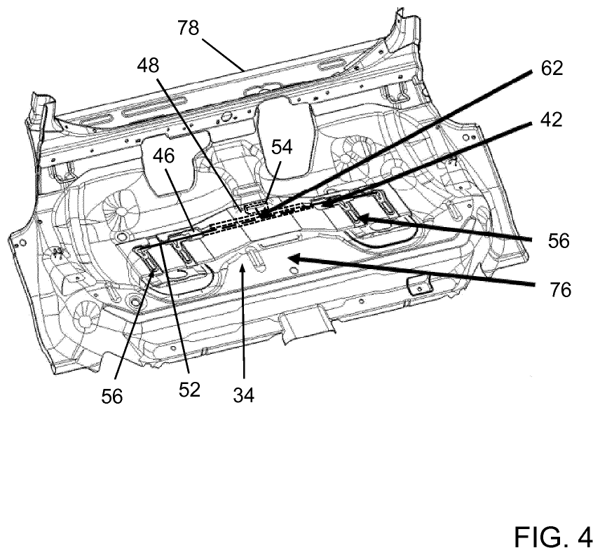

An alternative sensor carrier 36 in accordance with an embodiment of the invention is schematically shown in a perspective view in FIG. 3. FIG. 4 is a perspective view of an alternative vehicle seat occupation sensor unit 34 that comprises the alternative sensor carrier 36 pursuant to FIG. 3. The alternative vehicle seat occupation sensor unit 34 is shown in FIG. 4 in a state of being installed on the seat-supporting structure component 76 of the vehicle pursuant to FIG. 2.

The alternative sensor carrier 36 is e.g. completely made from extruded polystyrene (XPS) foam. In a top view, the alternative sensor carrier 36 also has a substantially rectangular shape.

Similar to the first embodiment of the sensor carrier 12 pursuant to FIG. 1, the sensor carrier 36 includes an upper surface 38 comprising two plane portions 40 that have a plane support area 42 for supporting vehicle seat occupation sensors. As illustrated in FIG. 3, in the installed state of the sensor carrier 36, the two plane support areas 42 are horizontally arranged. The two plane support areas 42 are each designed as a U-shaped lower-lying plane area at the bottom of an indentation in the upper surface 38. The sensor carrier 36 also comprises two inclined plane surface portions 44 for interconnecting the two plane portions 40.

The alternative vehicle seat occupation sensor unit 34 includes two vehicle seat occupation sensors 56, each of which has a substantially U-shaped form and one of which is disposed on each of the U-shaped plane support areas 42 that are arranged above the left-hand side and the right-hand side of the rear bench support, respectively. The vehicle seat occupation sensors 56 are attached to the plane support areas 42 by suitable means, for instance by using an adhesive or by employing clamps or snap-fits.

The sensor carrier 36 further comprises a bottom surface 50 that is arranged opposite to the upper surface 38. The bottom surface 50 is designed to follow a specified surface contour, which is the actual surface contour of the seat-supporting structure component 76 of the vehicle. The bottom surface 50 is designed such that a predetermined measure considering shortest distances between a plurality of reference locations 58 of a portion of the bottom surface 50 and corresponding reference locations of the specified surface contour of the seat-supporting structure component 76, in an installed state of the sensor carrier 36, are kept below a predetermined threshold value for the measure. For instance, the plurality of reference locations 58 can comprise several, several ten or even several hundred reference locations.

One possible employable predetermined measure is the sum of absolute values of the shortest distances between reference locations of a plurality of reference locations 58 (some of the reference locations 58 are exemplarily indicated in FIG. 3) of the portion of the bottom surface 50 and their corresponding reference locations of the specified surface contour of the seat-supporting structure component 76, wherein the sum is to be taken over all the reference locations of the plurality of reference locations 58.

The vehicle seat occupation sensor unit 34 further comprises electric cabling 52 that is electrically connected to the vehicle seat occupation sensors 56. The sensor carrier 36 comprises an elongated cabling indentation 46 that is configured for receiving the electric cabling 52. The indentations having a lower-lying plane area and the elongated cabling indentation 46 are connected with each other so as to form a continuous indentation. In contrast to the first embodiment, the alternative sensor carrier 36 includes a cover member 60 for partially covering the elongated cabling indentation 46 so as to create a cabling conduit 62 arranged in a center portion of the alternative sensor carrier 36.

Furthermore, the vehicle seat occupation sensor unit 34 includes a cable connector 54 that is electrically connected to the electric cabling 52, which, in turn, is connected to the four vehicle seat occupation sensors 56. Located at a center portion and covered by the cover member 60, the alternative sensor carrier 36 includes a cable connector indentation 48 in the upper surface 38 that is designed for receiving the cable connector 54.

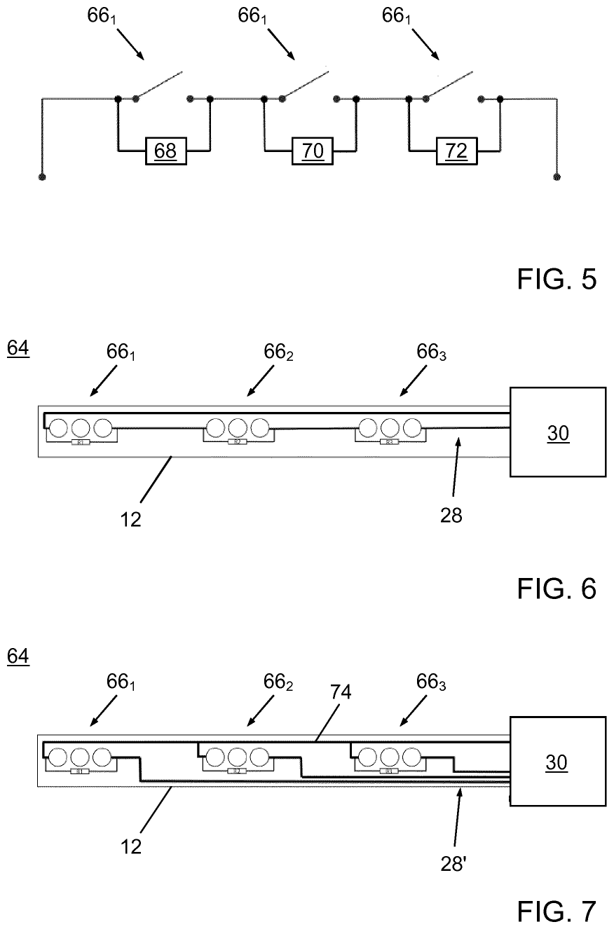

FIG. 5 shows an electric circuit diagram of a strip shaped sensor unit as shown in FIGS. 1 and 2 comprising a plurality of three vehicle seat occupation sensors 66₁, 66₂, 66₃ of a vehicle seat occupation sensor unit 64 that is arranged on a seat-supporting structure component (not shown) of a vehicle that is designed as a three-seat rear bench support. The vehicle seat occupation sensors 66₁, 66₂, 66₃ of the plurality of vehicle seat occupation sensors 66₁, 66₂, 66₃ are designed as pressure-sensitive switches 66₁, 66₂, 66₃. For instance, each one of the pressure-sensitive switches may be of the well-known foil-type pressure-sensitive switches.

One vehicle seat occupation sensor 66₁, 66₂, 66₃ each may be disposed on one of the three distinct plane support areas 18 designed as a lower-lying plane area at the bottom of an indentation in the upper surface 14 of the sensor carrier 12 pursuant to FIG. 1, such that each one of the three vehicle seat occupation sensors 66₁, 66₂, 66₃ is arranged below a seating position of the three-seat rear bench. The vehicle seat occupation sensors 66₁, 66₂, 66₃ of the plurality of three vehicle seat occupation sensors 66₁, 66₂, 66₃ are electrically connected in series.

FIG. 6 schematically illustrates a configuration of components of a vehicle seat occupation sensor unit 64 comprising the plurality of vehicle seat occupation sensors 66₁, 66₂, 66₃ pursuant to FIG. 5. Besides the sensor carrier 12 and the plurality of vehicle seat occupation sensors 66₁, 66₂, 66₃, the cable connector 30 and the electric cabling 28 is shown.

Referring again to FIG. 5, the vehicle seat occupation sensor unit 64 further comprises a plurality of resistors 68, 70, 72 having e.g. distinctive resistance values of 300 Ω, 600Ω and 1200Ω, respectively. The foil-type pressure-sensitive switches have a resistance value of less than 0.5Ω in the closed state so that a ratio of the largest resistance value and the lowest resistance of the three resistors 68, 70, 72 is at least 300/0.5=600. One resistor each of the plurality of resistors 68, 70, 72 is electrically connected in parallel to each vehicle seat occupation sensor 66₁, 66₂, 66₃ of the plurality of vehicle seat occupation sensors 66₁, 66₂, 66₃.

As shown by the table below, the 2³=8 possible states of occupation of the three seating positions of the three-seat rear bench are distinguishable by a resistance value to be measured across the three vehicle seat occupation sensors 66₁, 66₂, 66₃ electrically connected in series (for simplicity, resistance value of switches in closed state are assumed as 0Ω).

| | Resistance | Resistance | Resistance | Total |
|---|---|---|---|---|
| | Sensor | Sensor | Sensor | Resistance |
| Case | #1 [Ω] | #2 [Ω] | #3 [Ω] | [Ω] |
| # 1 | 0 | 0 | 0 | 0 |
| # 2 | 0 | 0 | 300 | 300 |
| # 3 | 0 | 600 | 0 | 600 |
| # 4 | 0 | 600 | 300 | 900 |
| # 5 | 1200 | 0 | 0 | 1200 |
| # 6 | 1200 | 0 | 300 | 1500 |
| # 7 | 1200 | 600 | 0 | 1800 |
| # 8 | 1200 | 600 | 300 | 2100 |

As shown in FIG. 6, as a result of the effort of measuring the total resistance, only two wires are required for the electric cabling 28 between the vehicle seat occupation sensors 66₁, 66₂, 66₃ and the cable connector 30.

An alternative electric configuration of the plurality of three vehicle seat occupation sensors 66₁, 66₂, 66₃ of the vehicle seat occupation sensor unit 64 pursuant to FIG. 6 with a modified electric cabling 28′ is schematically illustrated in FIG. 7. Herein, one end of each one of the vehicle seat occupation sensors 66₁, 66₂, 66₃ is electrically connected to one common lead 74 of the electric cabling 28 connected to the cable connector 30, and the other end of each one of the vehicle seat occupation sensors 66₁, 66₂, 66₃ is electrically connected directly to the cable connector 30. This solution obviates the necessity of a resistance measurement at the price of a higher cabling effort.

While embodiments of the invention have been illustrated and described in detail in the drawings and foregoing description, such illustration and description are to be considered illustrative or exemplary and not restrictive; the invention is not limited to the disclosed embodiments.

Other variations to be disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality of at least two. The mere fact that certain measures are recited in mutually different dependent claims does not indicate that a combination of these measures cannot be used to advantage. Any reference signs in the claims should not be construed as limiting scope.

1. A sensor carrier for being arranged on a seat-supporting structure component of a vehicle and for carrying at least one vehicle seat occupation sensor, the sensor carrier including:
an upper surface comprising at least one plane support area for supporting the at least one vehicle seat occupation sensor,
a bottom surface that is arranged opposite to the upper surface, wherein at least one portion of the bottom surface follows a specified surface contour of a seat-supporting structure component of a vehicle such that a predetermined measure considering shortest distances between a plurality of reference locations of the portion of the bottom surface and corresponding reference locations of the specified surface contour of the seat-supporting structure component, in an installed state of the sensor carrier, are kept below a predetermined threshold value for the measure.

2. The sensor carrier as claimed in claim 1, wherein the at least one plane support area is either a superficial upper plane area or a lower-lying plane area at the bottom of an indentation in the upper surface.

3. The sensor carrier as claimed in claim 1, wherein the at least one plane support area is horizontally arranged in the installed state of the sensor carrier.

4. The sensor carrier as claimed in claim 1, further comprising at least one cabling indentation that is configured for at least partially receiving electric cabling that is connectable to the at least one vehicle seat occupation sensor.

5. The sensor carrier as claimed in claim 4, wherein the at least one plane support area is a lower-lying plane area at the bottom of an indentation in the upper surface, and wherein the indentation having a lower-lying plane area and the at least one cabling indentation for at least partially receiving the electric cabling are connected with each other so as to form a continuous indentation.

6. The sensor carrier as claimed in claim 4, further including at least one cable connector indentation in the upper surface that receives a cable connector that is connectable to the electric cabling that, in turn, is connectable to the at least one vehicle seat occupation sensor.

7. The sensor carrier as claimed in claim 1, wherein a major portion of the sensor carrier is formed as plastic foam material.

8. A vehicle seat occupation sensor unit, comprising:
a sensor carrier as claimed in claim 1,
at least one vehicle seat occupation sensor that is disposed on the at least one plane support area,
electric cabling that is electrically connected to the vehicle seat occupation sensor, and
a cable connector that is electrically connected to the electric cabling.

9. The vehicle seat occupation sensor unit as claimed in claim 8, comprising:
a plurality of distinct plane support areas,
a plurality of vehicle seat occupation sensors, each one of the vehicle seat occupation sensors being attached to one out of the plurality of distinct plane support areas,
electric cabling that is electrically connected to the plurality of vehicle seat occupation sensors, and
at least one cable connector that is electrically connected to the electric cabling.

10. The vehicle seat occupation sensor unit as claimed in claim 9, wherein the vehicle seat occupation sensors of the plurality of vehicle seat occupation sensors are pressure-sensitive switches.

11. The vehicle seat occupation sensor unit as claimed in claim 10, wherein:
the vehicle seat occupation sensors of the plurality of vehicle seat occupation sensors are electrically connected in series,
the vehicle seat occupation sensor unit further comprises a plurality of resistors having distinctive resistance values, and
one resistor each of the plurality of resistors is electrically connected in parallel to each vehicle seat occupation sensor of the plurality of vehicle seat occupation sensors.

12. Use of the vehicle seat occupation sensor unit as claimed in claim 11 in a vehicle, wherein the seat-supporting structure component of the vehicle is the rear bench support of the vehicle.
